(19) United States
(12) Patent Application Publication
(10) Pub. No.: US 2019/0382652 A1
(43) Pub. Date: Dec. 19, 2019

(54) OIL FIELD CHEMICAL-CARRYING MATERIAL AND METHOD

(71) Applicant: JOHNSON MATTHEY PUBLIC LIMITED COMPANY, London (GB)

(72) Inventors: Aidan BRIERLEY, Billingham (GB); Chun-Tian ZHAO, Billingham (GB)

(21) Appl. No.: 16/338,571

(22) PCT Filed: Oct. 4, 2017
(86) PCT No.: PCT/IB2017/056107

§ 371 Date: Apr. 1, 2019

(30) Foreign Application Priority Data
Oct. 5, 2016 (GB) 1616925.2

(51) Int. Cl. C09K 8/92; C09K 8/80; E21B 47/10; E21B 43/26; E21B 49/08

(52) U.S. Cl. CPC C09K 8/92; C09K 8/80; E21B 49/08; E21B 47/1015; E21B 43/26; C09K 8/805

(57) ABSTRACT

An oil field chemical-carrying material comprising granulated particles is disclosed. The granulated particles comprise alumina. An oil field chemical is integrally incorporated into the granulated particle. The particles have been aged by heating the particles in a sealed or humid environment.

The present invention concerns oil field chemical-carrying materials, processes for producing oil field chemical-carrying materials, methods of delivering oil field chemicals, methods of monitoring subterranean formations, methods of tracing flow of fluid from hydrocarbon reservoirs and methods of hydraulic fracturing subterranean formations.

Hydraulic fracturing is common in the oil and gas exploration and production industry whereby a hydrocarbon-containing rock formation, or reservoir, is fractured in order to allow the hydrocarbon to flow out of the rock through the rock fractures. Many methods of fracturing a rock formation and maintaining a fracture open for the flow of hydrocarbon are known and practised in the industry. It is common to prop open a fracture by injecting proppant particles into the fracture so that flow of hydrocarbon from the fracture can be maintained.

A variety of oil field chemicals are used in oil wells. Examples of such chemicals include well treatment agents such as viscosity modifiers, density modifiers, flow modifiers, gelling modifiers, lubricants, foaming modifiers, scale inhibitors, disinfectants, anti-freezes or corrosion inhibitors. Examples of such well treatment agents include guar gum, acids including acetic acid, citric acid and phosphoric acid, sodium chloride, sodium carbonate, potassium carbonate, borate salts, glutaraldehyde, glycerol, isopropanol, ethylene glycol, lactose and polyacrylamide. It is desirable to introduce the oil field chemicals into the well in such a way as to control their release into the oil well over time so as to achieve a desired result from the oil field chemical overtime. Controlling the release over time may reduce the total material used, thus lowering costs and reducing environmental impact.

A particular example of an oil field chemical for which controlled release is desirable is tracers. It is well known to place tracers in a well in order to detect flow of fluid from a part of the well where a tracer has been placed. Radioactive tracers have been widely used for many years in well-monitoring applications. As an example, see U.S. Pat. No. 5,077,471, in which radioactive tracers are injected into a perforated well-bore, sealed and then monitored for decay to indicate the fluid flow from the formation. U.S. Pat. No. 4,755,469 describes the use of rare metal tracers for tracing oil and associated reservoir fluids by mixing an oil-dispersible rare metal salt with oil or an oil-like composition, injecting the dissolved tracer composition into a subterranean reservoir and analysing oil fluids produced from a different part of the reservoir for the presence of the rare metal to determine whether the oil mixed with the tracer has been produced from the reservoir.

It is also known in the art to trace the flow of fluids from a reservoir, including fluids flowing after a fracturing operation, using tracers. GB2518057 discloses a particulate tracer material comprising a plurality of particles of a porous particulate solid material. The particles have pores containing a tracer composition. A retaining material overlies the tracer composition in at least some of the pores. The retaining material retards the rate of discharge of the tracer compound from the tracer material compared with the rate of discharge from a similar tracer material in the absence of the retaining material. Particles of the particulate tracer material are joined together by means of a binder to form an agglomerated object.

The present invention seeks to provide improved materials and methods for introducing oil field chemicals, including tracers, into hydrocarbon wells.

### SUMMARY OF THE INVENTION

According to a first aspect of the invention there is provided an oil field chemical-carrying material comprising granulated particles comprising alumina and having been aged by heating the particles in a sealed or humid environment, wherein an oil field chemical is integrally incorporated into the granulated particles. By integrally incorporating the oil field chemical into the granulated particle a strong particle can be obtained which holds the oil field chemical securely so the oil field chemicals can be safely delivered. The particle does not degrade and instantaneously release the oil field chemical as soon as the particle is introduced into the well and instead the oil field chemical is slowly released. Desirably, the particle maintains its integrity during the delivery and therefore provides a structure for slow release of the delivered oil field chemical. Preferably the oil field chemical is microencapsulated. Thus the oil field chemical is slowly released from the microcapsule at a rate controlled by the particle structure and the properties of the microencapsulation. This has a significant advantage in that the release rate of the oil field chemical can be influenced by varying the microencapsulation properties independently of the material composition of the granulated particles or the granulation variables, such as the binder. That may allow the design of particles that are optimised both in terms of the physical properties of the particle (such as crush strength, durability, size distribution, manufacturing cost) and the release profile of the oil field chemical. In other prior art systems, where the choice of binder or the interaction of the particle with the oil field chemical due to adsorption or absorption may be a factor in determining both the release profile of the oil field chemical and the physical properties of the particles, such optimisation may not be possible and compromises may need to be made.

The granulated particles have been aged by heating the particles in a sealed or humid environment and preferably subsequently drying the particles. The aging process may improve the physical properties of the particles, including the crush strength and may permit the manufacture of particles with suitable properties for use in hydraulic fracturing operations using granulation with water as a binder and without the need for any polymeric binder. That has advantages in keeping the manufacturing costs of the particles low. Thus preferably the particles are granulated using water as a binder. It may be that the particles are granulated using a polymeric binder, which may provide further improved material properties. Preferably the particles are formed using activated alumina. Preferably the particles are formed using ρ-alumina. The aging process may be particularly effective when applied to ρ-alumina.

Preferably the granulated particles have been aged by heating the particles in a humid environment and preferably subsequently drying the particles. Preferably the particles have been aged by heating the particles in an environment having a humidity level of at least 50%. More preferably the particles have been aged by heating the particles in an environment having a humidity level of at least 90%. Most preferably the particles have been aged by heating the particles in an environment having a humidity level of 100%. The humid environment may be a sealed environment. The humidity level, typically referred to as ‘relative humidity’ and a well-known measure of humidity in the art, is the quantity of water vapour in the environment as a percentage of the quantity that would be present if the environment were saturated. It can be expressed as the ratio, in percentage terms, of the partial pressure of water vapour to the equilibrium vapour pressure of water at the temperature and pressure of the system.

Preferably the particles are from 0.1 to 3 mm in size. Particles of that size may be suitable for use with proppant material in hydraulic fracturing operations. The particles may function as proppant, or they may be mixed with proppant with the intention that they will end up in the same place as, and have similar durability to, the proppant particles with which they are mixed. It may be that the granulated particles are proppant particles.

Preferably the microencapsulation controls the rate of release of the oil field chemical from the oil field chemical-carrying material. The granulated particles may be coated, however preferably no coating or polymeric binder is needed to control the oil field chemical release or to contribute to the physical properties of the particles. Thus the granulated particles are preferably uncoated. Uncoated particles are simpler and cheaper to manufacture and may have lower material costs due to the absence of a coating.

Preferably the process for producing the oil field chemical-carrying material involves only a small number of steps and a small number of materials. Most preferably, the microencapsulated oil field chemical is integrally incorporated into the particles as they are formed. Thus, in a second aspect of the invention there is provided a process for producing an oil field chemical-carrying material, the process comprising: mixing alumina with a microencapsulated oil field chemical to produce a mixture, granulating the mixture using a binder, preferably water, to form granulated particles, aging the granulated particles by heating them in a sealed or humid environment, and drying the aged granulated particles to produce the oil field chemical-carrying material. The granulating preferably comprises shearing. Because the particles are formed from a mixture, preferably a homogeneous mixture, comprising alumina and the microencapsulated oil field chemical, the microencapsulated oil field chemical is integrally incorporated into the particles. Thus the particles comprise an intimate mixture of alumina and microencapsulated oil field chemical. For example, the microencapsulated oil field chemical may be embedded in a continuous body of solid alumina or the microencapsulated oil field chemical may be locked inside a volume within an alumina network. The microencapsulated oil field chemical is not merely coated onto the particles or adsorbed into pores in the particles. Instead, the particles comprise a mixture of alumina and microencapsulated oil field chemical. The microencapsulated oil field chemical is incorporated within the structure of the particles.

Preferably the heating is carried out at a constant temperature. Preferably the heating is carried out for a period of at least 4 hours. More preferably the heating is carried out for a period of at least 8 hours. Yet more preferably the heating is carried out for a period of at least 12 hours. Preferably the heating is carried out for a period of not more than 48 hours. More preferably the heating is carried out for a period of not more than 36 hours. Most preferably the heating is carried out for a period of not more than 24 hours. Preferably the heating is carried out for a period of 4 to 48 hours. Preferably the heating is carried out at a temperature of 40 to 80° C., more preferably 50 to 70° C. Preferably the heating is carried out in a sealed environment created by placing the granulated particles in a container, for example a bag, and sealing the container prior to the heating. The heating may be carried out in a humid environment. For example, the heating may be carried out in an environment in which there is a source of water. Preferably the humidity level in the environment is from 50% to 100%. More preferably the humidity level in the environment is from 90% to 100%. Most preferably the humidity level in the environment is 100%. The environment may be a sealed environment. The environment may be an environment that is not completely sealed but is nevertheless closed-off so that circulation of gas between the environment and the surroundings is restricted. An example of such a closed environment may be an oven with a closed door such as an incubator. As an example the heating may be carried out in an oven in which an open container of water has been placed. The heating process carried out at the above time, temperature and environmental conditions may advantageously age particles, for example particles comprising ρ-alumina, so that the strength of the particles is increased. Advantageously the strength of the particles is greatly increased by the aging process.

Preferably the material is dried at a temperature of 40 to 80° C., more preferably 50 to 70° C. The aged and dried particles may have suitable physical properties for use with, or as, proppant particles in hydraulic fracturing operations.

According to a third aspect of the invention, there is provided an oil field chemical-carrying material produced by the process of the second aspect of the invention.

Preferably the oil field chemical is a tracer. The invention may be particularly suited to use with tracers, since controlled release rates over time may be important in designing tracer products for particular applications. Thus, according to a fourth aspect of the invention, there is provided a method of monitoring a subterranean formation, the method comprising injecting, as part of a hydraulic fracturing operation, a fluid containing granulated particles comprising alumina wherein a microencapsulated tracer is integrally incorporated into the granulated particles, and detecting the tracer in fluids produced from the formation. Because the tracer is microencapsulated and the microcapsules are integrally incorporated into the particles, the release rate of the tracer from the microcapsules and hence from the tracer-carrying material can be controlled, for example to be slow and sustained. The high strength of the granulated particles comprising alumina, advantageously enhanced by aging and drying the particles as described above, means the particles can survive for an extended period of time, such as months or years, in the formation. The microencapsulated tracer can be delivered together with the particle to places where proppants are congregated. Since the microcapsules are integrally incorporated into the particles, the microcapsules themselves are not released for as long as the particles remain intact and instead the oil field chemical is released from the microcapsules in a controlled way, for example influenced by the rate of diffusion of the oil field chemical through the microcapsule. Thus the oil field chemical preferably passes through the microencapsulating materials and is released from the particle over a period of time. The oil field chemical is preferably released over an extended period of time of months or years. Preferably the oil field chemical is released over a period of at least 1 month, more preferably at least 2 months. More preferably the oil field chemical is released over a period of at least 6 months. Most preferably the oil field chemical is released over a period of at least 1 year. Preferably the release rate is constant (for example varying by less than 10%, preferably less than 5% and more preferably less than 2%) over a period of time, for example over 2 months and preferably over 6 months. The period of constant release may occur after an initial period of high or low release rate.

According to a fifth aspect of the invention there is provided a method of tracing a flow of fluid from a hydrocarbon reservoir comprising the steps of placing within a well penetrating said reservoir an oil field chemical-carrying material according to the invention, the oil field chemical being a tracer, thereafter collecting a sample of fluid flowing from the well, and analysing said sample to determine the presence or absence of the tracer.

According to a sixth aspect of the invention there is provided a method of hydraulic fracturing a subterranean formation, the method comprising injecting into the subterranean formation a fluid containing an oil field chemical-carrying material according to the invention.

According to a seventh aspect of the invention there is provided a method of hydraulic fracturing a subterranean formation comprising the steps of placing within the formation a plurality of particles, a microencapsulated oil field chemical being incorporated in each of the particles, such that the oil field chemical is released into the flow over time, wherein the rate of transport of the oil field chemical through the microencapsulation is slower than the subsequent rate of transport of the oil field chemical into the flow from the particle.

Preferably the particles are placed within the formation by injecting the particles along with a hydraulic fracturing fluid. For example, the particles may be mixed with proppant particles or may be proppant particles and may be introduced into the formation as part of the hydraulic fracturing operations using the techniques usually employed for proppant particles.

Preferably the rate of transport of the oil field chemical through the microencapsulation is substantially slower than the rate of transport of the oil field chemical into the flow from the particle so that the overall release rate of the oil field chemical is controlled by the microencapsulation. For example, the rate of transport of the oil field chemical through the microencapsulation is preferably not more than 10%, more preferably not more than 1%, yet more preferably not more than 0.1%, most preferably not more than 0.01%, of the rate of transport of the oil field chemical into the flow from the particle. Thus the step of the oil field chemical entering the flow from the particle may be fast compared to the rate of transport of the oil field chemical through the microencapsulation.

Preferably the oil field chemical is a tracer. Methods of the invention may optionally further comprise determining the concentration of one or more tracers in fluids flowing from the well. The methods may comprise taking a plurality of samples of fluids flowing from the well over a period of time, analysing the samples and determining the concentrations of one or more tracers in the reservoir fluids over time. The fluid which is to be traced may be a hydrocarbon fluid, i.e. an oil or gas or alternatively an aqueous fluid such as produced water. The materials of the invention may contain one or more tracers for tracing hydrocarbon flow and one or more different tracers for tracing water flows. In some embodiments it may be that the material includes a plurality of each of two or more different types of particle, each type of particle having a different microencapsulated tracer integrally incorporated within it. For example, a first type of particle may comprise a first microencapsulated tracer for tracing hydrocarbon flow and a second type of particle may comprise a second microencapsulated tracer for tracing water flows. In some embodiments it may be that the particles comprise two or more microencapsulated tracers. For example, each particle may comprise a first microencapsulated tracer for tracing hydrocarbon flow and a second microencapsulated tracer for tracing water flows. In some embodiments it may be that the tracer-carrying material consists of a single type of particles. The particles may comprise one or more microencapsulated tracers for tracing hydrocarbon flow, the particles may comprise one or more microencapsulated tracers for tracing water flows, the particles may comprise one or more microencapsulated tracers for tracing hydrocarbon flow and one or more different microencapsulated tracers for tracing water flows. All the microencapsulated tracers may be integrally incorporated into the particles. Preferably all of the microencapsulated tracers are integrally incorporated into the particles when the particles are formed by granulation of a mixture comprising alumina, preferably ρ-alumina, and the microencapsulated tracers.

The particles of the invention may be formed by granulation, for example wet granulation. During the granulation the particles form into clusters of particles held together by a binder, preferably water. Subsequent aging and drying may form particles with satisfactory crush strength. Wet granulation may be particularly preferable in that it may permit a large quantity of oil field chemical-carrying material to be made in an efficient way and with good roundness and sphericity. Granulation, for example wet granulation, is advantageously a scalable, cheap technique, and the invention advantageously uses cheap starting materials, to produce a material that is strong, and bound together well so that the material doesn't disintegrate. The material is advantageously non-toxic, easy to handle, and allows high oil field chemical loading for reasonable strength. The use of the aging is particularly advantageous as it may improve strength and produce particles that are harder than other granulated particles so granulation can be used to achieve the advantageous above while also providing acceptable hardness for demanding applications.

The particles produced by the process of the invention are advantageously hydrophilic and have a density such that they are carried along with aqueous fracturing fluids. The particles are advantageously smooth and round so they pour and mix well, and are preferably the same size as other proppant particles so they don't segregate during storage or transport. Preferably the particles are unmoulded particles in that they are formed without the use of a mould and without any compressive moulding. Preferably the particles are uncompacted particles in that no compaction step is carried out during production of the particles. That may advantageously produce an oil field chemical-carrying material having improved oil field chemical elution properties. For example, the transport of the oil field chemical from the uncompacted particles may be fast relative to the release of the oil field chemical through the microencapsulation, thus allowing the release rate to be controlled by the microencapsulation.

Preferably the particles have a sphericity of 0.5 or greater. Preferably the particles have a roundness of 0.5 or greater. More preferably the particles have a sphericity of 0.6 or greater. More preferably the particles have a roundness of 0.6 or greater. The sphericity and roundness may be measured in accordance with BS EN ISO 13503-2:2006+A1:2009. The oil field chemical-carrying material will typically be mixed, for example dry mixed, with proppant material in preparation for being introduced into the well with the proppant material. The oil field chemical-carrying material may be introduced into the well at the same time as the proppant to allow mixing during injection. The particles may mix more easily than oil field chemical-carrying materials formed of a non-agglomerated particulate material due to the improved shape characteristics of the particles. It may be that the particles have a size of between 0.425 and 3 mm, preferably between 0.425 and 1.18 mm. Preferably the particles have a size of between 8 and 140 mesh (that is, between 105 μm and 2.38 mm), preferably between 16 and 70 mesh (that is, between 210 μm and 1.19 mm), and more preferably between 40 and 70 mesh (that is, between 210 μm and 420 μm). In some embodiments the particles may have a size of between 30 and 50 mesh (that is, between 297 μm and 595 μm), between 40 and 70 mesh (that is, between 210 μm and 420 μm) or between 70 and 140 mesh (that is, between 105 μm and 210 μm). In that way the particles may match the size of typical proppant materials.

The particles comprise alumina. Preferably the particles comprise at least 50% by mass, more preferably at least 60% by mass, more preferably at least 70% by mass, more preferably at least 80% by mass and more preferably at least 90% by mass alumina. The particles also comprise the microencapsulated oil field chemical. Optionally the particles further comprise materials, such as additives to improve the mechanical properties of the particles. A preferred additive is Attagel® from BASF. Preferably the Attagel® is added at a level of 5% by mass. Preferably the particles comprise 0.05% to 80% by mass, preferably 1% to 40% by mass, and most preferably 5% to 20% by mass of oil field chemical, particularly tracer.

The alumina may have a mean size of not greater than 500 μm, and preferably not greater than 250 μm. In some embodiments the alumina may have a size not greater than 200 μm or not greater than 100 μm. The alumina may have a size of not less than 10 μm and more preferably not less than 50 μm. The size of the alumina can be determined by techniques including light microscopy, sedimentation, sieving and laser diffraction techniques using, for example, Malvern or Sympatec instruments. The laser diffraction techniques measure the volume weighted diameter of sphere particles directly. For non-spherical particles, volume equivalent spherical diameter is measured. Mean (arithmetic average), mode (most frequent) or median (where 50% of the population is below/above) values may be taken as representative particle size of a population. As used herein, the measured volume weighted mean diameter of the alumina is taken as the representative particle size of the alumina.

Preferably the oil field chemical-carrying material comprises a microencapsulated tracer. Preferably the tracer is not naturally found in the fluid, the flow of which is to be traced. Suitable hydrocarbon-soluble tracers are known to the skilled person. The tracer is preferably a liquid or solid at room temperature. More than one tracer may be incorporated into the particles. The tracer may comprise a dye which can be detected by visual means or by a spectroscopic method. The dye may be coloured or not coloured to the eye. Fluorescent compounds, detectable by fluorescence spectroscopy, are well-known for use as tracers and may be suitable for this application. Chemical tracer compounds may be used as tracers. Such compounds may be detected by liquid or gas chromatography coupled to mass spectroscopy, electron capture detectors or other methods of detection. Atomic absorption spectroscopy or other methods may be used. The tracer is preferably a solid or liquid which is soluble in or miscible with a hydrocarbon fluid, especially a naturally-occurring oil or gas, or soluble in or miscible with an aqueous liquid. The tracer is preferably soluble in or miscible with produced fluids in the form of naturally-occurring oil, gas or produced water found in subterranean reservoirs. The selection of suitable tracers is known in the art and the skilled person is capable of selecting one or more appropriate tracers.

Suitable tracers include, but are not limited to classes of materials such as dyes, fluorescent materials, emissive materials, aromatic compounds (preferably halogenated aromatic compounds), cyclic compounds (preferably cycloalkanes, especially halogenated cycloalkanes) and aliphatic compounds (preferably halogenated aliphatic compounds). Each of these compounds having suitable functional groups, or derivatives of such functional groups, including but not limited to: alkyl, alkenyl, alkynyl, nitro, aldehyde, haloformyl, carbonate ester, amine, hydroxyl, phenyl, benzyl, carboxylate, sulfonate, carbonyl, acetal, halogen, partially or completely halogenated hydrocarbon chains or cycles, carboxyl, ester, methoxy, ethoxy, hydroperoxy, peroxy, ether, sulfo, borono, borate, boronate, orthoester, carboxamide, amide, nitrile, isonitrile, thiol, sulphide, or sulfonyl, or any combination of those groups. Suitable tracers include but are not limited to 4-bromodiphenyl ether, 4-bromobenzophenone, heptadecafluoro-1-decane, 1,5-diaminoanthraquinone, (1-bromoethyl)benzene, 2-bromoethylethylether, 5-chloro-3-phenyl-2,1-benzisoxazole, 2,4′-dichloroacetophenone, and 1-chloroanthraquinone.

More than one tracer may be contained within the same tracer-carrying material. Different combinations of tracers may be used in different tracer-carrying materials to identify different flows. Tracer-carrying materials containing different tracers or different combinations of tracers may be placed in different locations, e.g. at different parts of a well, so that passing fluid contacting each tracer-carrying material at its respective location may be identified.

When different tracer-carrying materials are used in a well, they may be designed to release tracers at different rates by appropriate selection of the microencapsulation. In this way fluid contacting the tracer-carrying materials may be detected at different stages in the production history of the well. The microencapsulated tracers in each tracer-carrying material may be the same or different. Different tracer-carrying materials containing different tracers may be made readily identifiable by colouring the tracer-carrying materials or applying other visible indicators.

The oil field chemical-carrying material may be used as, or with, proppant particles, whereby they are added to a fracturing fluid treatment and forced into fractures created in a rock formation. The oil field chemical-carrying material may remain in the fracture and may release the oil field chemical from the material when the material is in contact with a flow of hydrocarbon fluid. Preferably the oil field chemical-carrying material is used with other proppant particles so that only a proportion of the material forced into a fracture is oil field chemical-carrying material. The oil field chemical-carrying material of the invention may be especially advantageous for such applications because of the improved sphericity and roundness of the particles. The proportion of oil field chemical-carrying material to (non-oil field chemical-containing-) proppant can depend upon a number of factors, such as the production rate of the well, which effects the dilution of the oil field chemical in the produced fluid, the length of time that a release of oil field chemical into the production fluid is desired and the level of oil field chemical in the production fluid that is desired. When the oil field chemical is a tracer, the desirable level of the tracer in the production fluid may be determined based on the sensitivity of the analytic method used to detect the tracer. One of skill in the art would be able to determine the proportion of oil field chemical-carrying material to proppant based on these factors. The oil field chemical-carrying material is preferably free-flowing in that it can be poured from a container and does not significantly aggregate.

The oil field chemical-carrying material may alternatively be placed at locations within a well associated with the completion apparatus, e.g. filters, well liners etc. For such applications, the oil field chemical-carrying material may be placed in a container which is suitably perforated in order to allow the well fluids access to the material whilst retaining the material within the container. As an alternative embodiment the oil field chemical-carrying material may be formed, for example moulded, into an agglomerated object. That is, an agglomerated object may be formed by agglomerating the particles of the oil field chemical-carrying material. In particular, the material may be formed into one or more shaped agglomerated objects which can be placed within a well. Such shaped agglomerated objects may, for example, take the form of strips or mats which are formed by moulding the particles of the oil field chemical-carrying material into the required shape with a binder to bind the particles of the oil field chemical material to each other. The particles of the oil field chemical-carrying material are placed in a mould before the binder is solidified. The binder may, if required, be selected to be broken down on contact with the well fluids if it is required to release the oil field chemical-carrying material from the agglomerated article when the article has been placed in the well. It may be particularly advantageous to use an oil field chemical-carrying material that will not degrade, or degrades only slowly, for example over the course of years or longer and a binder that breaks down rapidly, for example over the course of at most years, months, or weeks. For example, 90% by mass or more, preferably 95% or more and more preferably 99% or more of the oil field chemical-carrying material may remain after 1 year or more, preferably 2 years or more and more preferably 3 years or more in the well and 20% by mass or less, preferably 10% or less and more preferably 5% or less of the binder may remain after 1 year, 1 month, or 1 week. In some embodiments, the oil field chemical-carrying material may degrade at a rate that is 25% or less, preferably 10% or less, more preferably 1% or less and yet more preferably 0.1% or less of the rate at which the binder breaks down. In that way an object may be provided that is inserted as an object but that then breaks down to release the oil field chemical-carrying material into the well or formation.

The oil field chemical-carrying material described above, when used in oil wells, can provide detectable levels, that is levels above 1 ppb, preferably above 10 ppb, more preferably above 100 ppb and yet more preferably above 1 ppm, of one or more oil field chemicals in production fluids for periods of at least 1 month, at least 2 months, at least 3 months, at least 6 months, at least 9 months, at least 12 months, at least 15 months, at least 18 months, at least 21 months or at least 24 months. Preferably the oil field chemical is a tracer.

An advantage of providing an oil field chemical-carrying material comprising a plurality of separate particles is that the process of forming the particles, for example by wet granulation, permits the incorporation of multiple oil field chemicals into the oil field chemical-carrying material to provide additional functionality. In some embodiments, the particles may further comprise one or more additional compositions to alter the particle properties. The additional composition is preferably a non-oil field chemical composition. For example, the additional composition may be a strengthening material. The oil field chemicals may, for example, be a well treatment agent such as a viscosity modifier, density modifier, flow modifier, gelling modifier, lubricant, foaming modifier, scale inhibitor, disinfectant, anti-freeze or corrosion inhibitor. Examples of such well treatment agents include guar gum, acids including acetic acid, citric acid and phosphoric acid, sodium chloride, sodium carbonate, potassium carbonate, borate salts, glutaraldehyde, glycerol, isopropanol, ethylene glycol, lactose and polyacrylamide. Other well treatment agents will be known to the skilled person. Preferably the multiple oil field chemicals, which are preferably separately microencapsulated, are integrally incorporated into the particles. The multiple oil field chemicals may be incorporated, preferably as microencapsulated compositions, when the particles are formed. For example, the multiple microencapsulated oil field chemicals may be mixed with the alumina prior to the granulation. The one or more additional compositions are preferably also mixed with the alumina prior to the granulation. In some embodiments the one or more additional compositions may be coated onto, or otherwise adsorbed or absorbed onto or into, the particles after they are formed.

A broad aspect of the invention provides the provision of a material for injection into an underground formation, the material comprising a plurality of separate particles, each particle having a microencapsulated composition integrally incorporated therein. According to the invention there may be provided an oil field chemical-carrying material comprising granulated particles, preferably comprising alumina, wherein a microencapsulated oil field chemical is integrally incorporated into the granulated particles. The material is preferably a proppant material. The injection is preferably injection with a proppant material. The underground formation is preferably a hydrocarbon well and is more preferably a hydrocarbon well undergoing hydraulic fracturing. The particles may comprise a mixture of particles. The particles may comprise one or more compositions selected from the group comprising tracers, viscosity modifiers, density modifiers, flow modifiers, gelling modifiers, lubricants, foaming modifiers, scale inhibitors, disinfectants, anti-freezes or corrosion inhibitors.

Preferably the microencapsulated oil field chemical is a microcapsule comprising the oil field chemical and a polymeric microencapsulant, where the microcapsule comprises a core shell structure, a core multi-shell structure, a multi core shell structure, a micro matrix structure, a micro matrix with shell structure or a multi core micro matrix with shell structure. Other compositions may be microencapsulated in the same way. Microencapsulated oil field chemicals, including tracers, suitable for use in the present invention are described in PCT application numbers GB2016/051172 and GB2016/051173.

The microcapsule preferably has either (a) a core comprising the oil field chemical with a shell around the core or (b) a micro matrix comprising the oil field chemical with or without a shell.

The term “core” refers to the central inner portion of a composition. The core can be a simple phase of oil field chemicals, or a mixture comprising one or more oil field chemicals and non-polymeric materials. The core can contain a mixture of a plurality of sub cores and non-polymeric materials. This configuration of a plurality of sub cores is referred to as a “multicore.” Each of the sub cores comprise one or more oil field chemicals or other oil field chemicals as discussed above. Each of the sub cores can be surrounded by a polymeric shell.

The term “micro matrix” refers to a three dimensional structure on micro scale, i.e., with a size from nanometre to sub millimetre. The three dimensional structure is made of polymers and contains one or more oil field chemicals distributed within the structure. A micro matrix can be regarded as a special type of core. It differs from normal cores in that it has a 3 dimensional polymeric structure. The polymers can be pre formed or formed in situ by polymerization of monomers. The micro matrix can have oil field chemicals molecularly distributed in the entire micro matrix structure or comprise a plurality of sub cores, each containing an oil field chemical.

Preferably the microencapsulants form a three dimensional structure in the form of shells or micro matrixes that contain the cores, sub cores, multi cores or oil field chemicals. Preferably the shell is a polymeric coating that at least partially surrounds a core or a micro matrix. The microencapsulant may comprise any polymer material that can form the major portion of a shell or micro matrix to microencapsulate the oil field chemical. Examples of such materials include, but are not limited to melamine formaldehyde, urea formaldehyde, phenol formaldehyde resin, melamine phenol formaldehyde resin, furan formaldehyde resin, epoxy resin, ethylene vinyl acetate copolymer, polypropylene polyethylene copolymer, polyacrylates, polyesters, polyurethane, polyamides, polyethers, polyimides, polyether ether ketones, polyolefins, polystyrene and functionalized polystyrene, polyvinylalcohol, polyvinylpyrrolidone, cellulose and cellulose derivatives, starch and starch derivatives, polysiloxanes, and mixtures thereof.

The materials used to form the shell or micro matrix can also include non-organic materials, such as silica, calcium carbonate or inorganic polymers, such as polyphosphazenes. The materials used to form the shell or micro matrix can be organic/inorganic hybrid materials, such as hybrid silica/polyamide materials.

The microcapsules can comprise at least one of the following structures:
(a) a core shell structure comprising:
   i. a core comprising at least one oil field chemical and
   ii. a shell comprising a polymeric microencapsulant;
(b) a core multi shell structure comprising:
   i. a core comprising at least one oil field chemical,
   ii. a first shell comprising a polymeric microencapsulant located adjacent to the core; and
   iii. one or more additional shells located over the first shell, each additional shell comprising a polymeric microencapsulant that is different than the polymeric microencapsulant in an adjacent shell;
(c) a multi core shell structure comprising
   i. a core comprising a plurality of sub cores where each sub core comprises at least one oil field chemical, and optionally having a shell at least partially covering each of the sub cores, and the sub cores are dispersed in a non-polymeric compound, and
   ii. a shell comprising a polymeric microencapsulant;
(d) a micro matrix structure comprising a core comprising at least one oil field chemical entrapped within a micro matrix comprising a polymeric microencapsulant;
(e) a micro matrix with a shell structure comprising
   i. a core comprising at least one oil field chemical entrapped within a micro matrix comprising a polymeric microencapsulant; and
   ii. a shell comprising a polymeric microencapsulant;
(f) a multi core micro matrix with a shell structure comprising
   i. a micro matrix comprising a plurality of sub cores, where each sub core comprises at least one oil field chemical, and the sub cores are entrapped within the micro matrix, and
   ii. a shell comprising a polymeric microencapsulant.

The oil field chemical can be present at 1 to 99.5% by weight of the microcapsule. Preferably the oil field chemical is present at 10 to 98% by weight of the microcapsule.

The microcapsules can have a volume weighted average particle size of between 0.05 μm and 600 μm, inclusive. Preferably the average particle size is between 0.1 μm and 500 μm, inclusive. The size of the microcapsules can be determined by a laser diffraction technique using a Malvern or Sympatec instrument. This method measures the volume weighted diameter of sphere particles directly. For non-spherical particles, volume equivalent spherical diameter is measured. Mean (arithmetic average), mode (most frequent) or median (where 50% of the population is below/above) values may be taken as representative particle size of a population. As used herein, the measured volume weighted mean diameter of the microcapsules is taken as the representative particle size of the microcapsules.

The microencapsulated oil field chemical may be formed by a physical method, a chemical method or a physico-chemical method. The physical method can be selected from the group consisting of spray drying, fluidised bed coating, co extrusion, and solvent evaporation.

It is preferred that microcapsules are made by spray drying a mixture of the oil field chemicals and polymers.

In another preferred method, microcapsules containing oil field chemicals are made by co-extrusion of two phases of polymers or mixture of polymers. An inner phase is a mixture of a polymer or pre-polymer containing the oil field chemicals. An outer phase is a mixture of a polymer or pre-polymer containing either no oil field chemical or less oil field chemical than is present in the inner phase.

Microcapsules can be formed by chemical methods using one or more in-situ reactions. A preferred chemical method of this invention forms microcapsules by the in-situ polymerization of monomers distributed in an emulsion containing one or more oil field chemicals.

Microcapsules with core shell structures can be prepared by dispersing an oil field chemical, a mixture of an oil field chemical with non-polymeric materials, or a mixture of an oil field chemical with non-polymeric materials and monomers into small particles in the form of an emulsion with the aid of physical force and emulsifiers. Stabilizers can be used to stabilize the emulsions when they are formed. Monomers or pre-polymers can be distributed in the interphase, the continuous phase or in both phases. The monomers can be polymerised and deposited on the cores or other shells to form the shells. A pre-formed polymer can also be added to the emulsions and deposited together with newly formed polymers to form the shells. The polymer can be cured during or after the polymerisation process. Alternatively, monomers or pre-polymers can be deposited on the core and then the pre-polymers can be cured to form a polymer coating.

Micro matrix type microcapsules can also be formed by polymerisation from emulsions. A mixture of oil field chemicals with a high concentration of monomers, pre-polymers, a combination of monomers and pre-polymers, or a combination of monomer/pre-polymer and a pre-formed polymer, can be dispersed to form an emulsion. Polymerisation and/or curing (crosslinking) of monomers inside droplets or a dispersed internal phase can form a micro matrix containing the oil field chemicals. During this process, the structure of the mixture will undergo changes. For example, at the beginning of the process, the oil field chemicals may be molecularly distributed, however at the end of the process they can form very fine phases in the microcapsules or can still be molecularly distributed.

The physico-chemical method can be coacervation phase separation.

Micro matrixes, core shell particles or micro matrixes with shells can be prepared beforehand. These micro particles can then be exposed to gas or oil field chemicals and the oil field chemicals can be absorbed and/or adsorbed by the microparticles.

Microcapsules can be recovered as solid powders using methods include centrifugation and/or filtration followed by drying. Drying methods can include evaporation of solvent or water in the air, drying in a vacuum oven or fluidised bed, etc.

Both solid and liquid oil field chemicals can be microencapsulated and recovered as solid powders.

Microcapsules may be treated after they are formed. The treatment can be physical or chemical. For example, one or more different chemicals can be added to the emulsion system after the formation of the microcapsules. In such treatments, no additional shell is formed. Rather the surface properties of the microcapsules are altered due to adsorption or reaction at the outer surface of the pre formed microcapsules. The chemical can have a physical interaction, such as deposition, or a chemical reaction with the first-formed shells or micro matrixes. As such, the properties of the microencapsulant can be modified for example to allow different chemical groups to become attached to the outer surface of the microcapsules or to enhance the stability or barrier properties of the microencapsulant. One particular chemical treatment is grafting of new polymers onto the surface of the microcapsules.

By microencapsulating oil field chemicals and post-treating the microcapsules using the above methods, microencapsulated oil field chemical with various functional chemical groups can be prepared. The functional chemical groups can be reactive. Examples of such chemical groups can be selected from the group consisting of carboxylates, amines, quaternised amine, anhydrides, hydroxyls, isocyanates, phosphates, nitriles, esters and aldehydes, silanol, N methylol etc.

The oil field chemical-carrying materials preferably provide controlled release rate profiles. One of ordinary skill in the art would recognize that typical dissolution type testing at elevated temperatures representing those found in a hydrocarbon reservoir using an eluent representative of oil can be used for testing release rates. Typical dissolution type testing involves placing a material containing a compound of interest into an eluent with stirring, taking samples of the eluent at various times and determining the amount of the compound of interest that is present in the eluent over time. From this information, a graph of the cumulative amount of the compound of interest released over time can be produced. Comparisons of length of time needed to release a desired amount of compound of interest can be made based on the profile of the data.

The oil field chemical-carrying materials can provide for the release of an oil field chemical into eluents representative of oil under the test conditions described herein such that measureable concentrations of the oil field chemical can be obtained in the eluent for at least 2 months, preferably at least 4 months, more preferably at least 6 months, particularly at least 1 year after the oil field chemical-carrying material has been placed in the test system.

Preferably, the oil field chemical-carrying materials can provide for the release of an oil field chemical into eluents representative of oil under the test conditions described herein such that that less than 50% of the oil field chemical is released into the eluent over a period at least 2 months, preferably at least 3 months, more preferably at least 6 months, particularly at least 1 year after the article has been placed in the test system. Some oil field chemical-carrying materials can provide for the release of the oil field chemical for preferably at least 2 years, more preferably at least 5 years after the oil field chemical-carrying material has been placed in the test system.

The oil field chemical-carrying materials can provide for the release of an oil field chemical into the oil well fluids in a hydrocarbon reservoir such that measureable concentrations of the oil field chemical can be obtained for at least 2 months, preferably at least 4 months, more preferably at least 6 months, particularly at least 1 year after the oil field chemical-carrying material has been placed in a hydrocarbon reservoir. Some of the oil field chemical-carrying materials can provide release of the oil field chemical into the oil well fluids in a hydrocarbon reservoir such that measureable concentrations of the oil field chemical can be obtained for at least 2 years, preferably at least 5 years after the oil field chemical-carrying material has been placed in a hydrocarbon reservoir.

The oil field chemical-carrying material can release at one of the following percentages of the applied dose of oil field chemical present in the microcapsule over a period of 45 days at 60° C. in a fluid representing an oil field fluid: <45%, preferably <40%, more preferably <30%, even more preferably <25%, particularly <20%, more particularly <15%, even more particularly <10%, especially <5%, more especially <1% and even more especially <0.5%.

When the oil field chemical is a tracer, the oil field chemical-carrying materials described herein have numerous applications in the area of detecting and tracing the movement of oil field fluids in a hydrocarbon reservoir. When the oil field chemical is a tracer, the oil field chemical-carrying materials described herein can be used in monitoring/tracing a flow of fluid from a hydrocarbon reservoir. The oil field chemical-carrying materials can be placed or delivered downhole to near well bore positions relative to well casings. Ingress and in-flow of gas, oil, water or mixtures of oil and water can be detected and monitored.

A method of tracing fluid flow from a hydrocarbon reservoir can comprise the steps of placing within a well penetrating the reservoir an oil field chemical-carrying material of the invention, the oil field chemical being a tracer, collecting one or more sample of fluids flowing from the well and analysing said sample(s) to determine at least one of the presence or absence of the tracer and the concentration of the tracer in fluids flowing from the well. The method can further comprise one or more of the following steps: collecting a plurality of samples of fluids flowing from the well over time, analysing the samples and determining the presence or absence of the tracer in the sample, and analysing the samples and determining the concentrations of tracer in the reservoir fluids over time. The oil field chemical-carrying material can be placed at, around or within a fracture in a rock formation forming said reservoir or at around or within a bore hole, or within, or attached to, a well completion apparatus installed within the well.

Methods used to monitor/trace a flow of fluid from a hydrocarbon reservoir comprise the following steps: (a) introducing tracer-carrying materials to locations in a well or formation, (b) thereafter collecting a sample of fluid flowing from the well and analysing the sample to determine the presence or absence of the at least one tracer and optionally determining the concentration of one or more tracers in fluids flowing from the well, (c) collecting and analysing a plurality of samples of fluids flowing from the well over a period of time and determining the concentrations of one or more tracers in the reservoir fluids, and (d) analysing the concentrations of the tracer to determine a pattern of back flow to obtain further reservoir flow information.

In one aspect of the invention, tracer-carrying materials (that is, oil field chemical-carrying materials, wherein the oil field chemical is a tracer) comprising a plurality of tracers are placed at different locations along the length of a well penetrating a reservoir, during completion of the well before production begins. The tracer-carrying material at each location can be attached to a section of pipe before it is placed at that location or delivered into the location after perforation of the casing. When production begins, detection and quantification of the individual tracers in the oil or gas produced by the well provides ways to monitor and quantify the oil or gas being produced from different zones of the reservoir.

In another aspect of the present invention, more than one tracer can be used to measure multiple operations in the same well. For example, oil wells often have more than one producing strata or zone. A stratum could be fractured using a first tracer-carrying material and a different stratum could be fractured using a second tracer-carrying material. Horizontal drilling allows for the drilling of multiple bores terminating in a common bore which connects to the surface. In multilateral wells such as these, several different tracers could be used to keep track of concurrent recovery of materials from the several legs (lateral bores) of such wells. These methods can be used to monitor and track the flow of fluid from such wells.

A method of treating a hydrocarbon reservoir penetrated by a well can comprise the step of placing within a well penetrating the reservoir an oil-field-chemical-carrying material, the oil-field-chemical-carrying material comprising granulated particles comprising alumina, wherein a microencapsulated oil field chemical is integrally incorporated into the granulated particle, and the oil field chemical is a well treatment agent. The method can further comprise one or more of the following steps: collecting samples of fluids flowing from the well over time, analysing the samples and determining the presence or absence of a targeted chemical compound in the sample, and analysing the samples and determining the efficiency of the treatment over time. The targeted chemical may be the well treatment agent or may be a chemical affected by the well treatment agent. The oil-field-chemical-carrying material can be placed at, around or within a fracture in a rock formation forming the reservoir or at around or within a bore hole, or within, or attached to (for example in a container as described above), a well completion apparatus installed within the well. The well treatment agent may, for example be a biocide.

The reservoir formation being treated and analysed in the above methods can be fractured. The oil-field-chemical-carrying material can also be delivered to the fractured formations within a liquid. Thus the oil-field-chemical-carrying material described herein can be added to a fluid (such as a stimulation fluid or a flooding fluid for primary and secondary oil recovery). The oil-field-chemical-carrying material can also be mixed with proppants or used as proppants. In such embodiments, the release of the tracer from tracer-carrying materials of the invention may be used to trace fluid movements associated with various operations associated with fracking and stimulation, and the release of well treatment agents, such as corrosion inhibitors and biocides, from well treatment agent-carrying materials of the invention may be used to provide protection to downhole pipeline and equipment and assurance of flow within the pipelines.

Oil-field-chemical-carrying materials of the invention comprising microcapsules comprising well treatment agents can be used to place well treatment agents in reservoirs and/or well pipes and provide for the sustained release of well treatment agents of periods of time from over a period at least 2 months, preferably at least 4 months, more preferably at least 6 months, particularly at least 1 year after the oil-field-chemical-carrying material has been placed in the test system. Some systems can release for at least 2 years, preferably at least 5 years after the oil-field-chemical-carrying material has been placed in the test system.

The oil-field-chemical-carrying materials described above can comprise a single oil field chemical where the oil-field-chemical-carrying material provides for at least two different release profiles of the oil field chemical. For example, an oil-field-chemical-carrying material can comprise microcapsules integrally incorporated in granulated particles, where a single oil field chemical is encapsulated within the core of the microcapsule and is also placed within the outer shell of the microcapsule. The oil field chemical in the outer shell provides for a rapid release (days to weeks) of the oil field chemical, while the oil field chemical in the core is released more slowly. In a further example, an oil-field-chemical-carrying material comprises a granulated particle with two or more different types of microcapsules containing the oil field chemical. One type of microcapsule provides a slower release (months to a year or more) of the oil field chemical, while the other type of microcapsule provides for release at a different (e.g. more rapid, days to weeks) rate for the oil field chemical.

The oil-field-chemical-carrying materials described above can comprise two or more oil field chemicals where the oil-field-chemical-carrying material provides for at least two different release profiles. For example, an oil-field-chemical-carrying material comprises a granulated particle with two or more different microencapsulated oil field chemicals integrally incorporated in the particle. Preferably the granulated particle comprises alumina, more preferably aged alumina as described above. The microcapsule of a first microencapsulated oil field chemical provides a first release rate (e.g. release over a period of months to a year or more) for the first microencapsulated oil field chemical, while the microcapsule of a second microencapsulated oil field chemical provides for release at a different rate (e.g. more rapid, release over a period of days to weeks) for the second microencapsulated oil field chemical.

It will be appreciated that features described in relation to one aspect of the invention may be equally applicable to other aspects of the invention. For example, features described in relation to an oil field chemical-carrying material of the invention may be equally applicable to a method of the invention and vice versa. It will also be appreciated that optional features may not apply, and may be excluded from, certain aspects of the invention.

### DESCRIPTION OF THE DRAWINGS

The invention will be further described by way of example only with reference to the following figures, of which:

FIGS. 1A to 1F are representations of structures of different configurations of microcapsules;

FIGS. 2A to 2C are tracer release graphs for microencapsulated and non-microencapsulated tracers; and

FIG. 3 is a graph of crush strengths.

### DETAILED DESCRIPTION

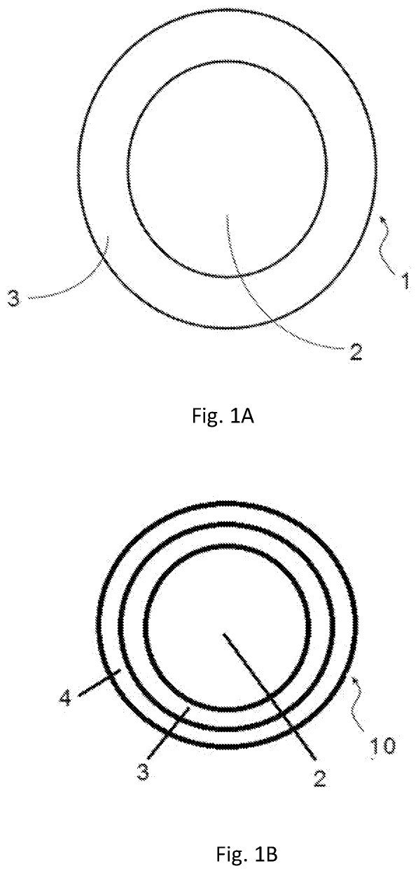

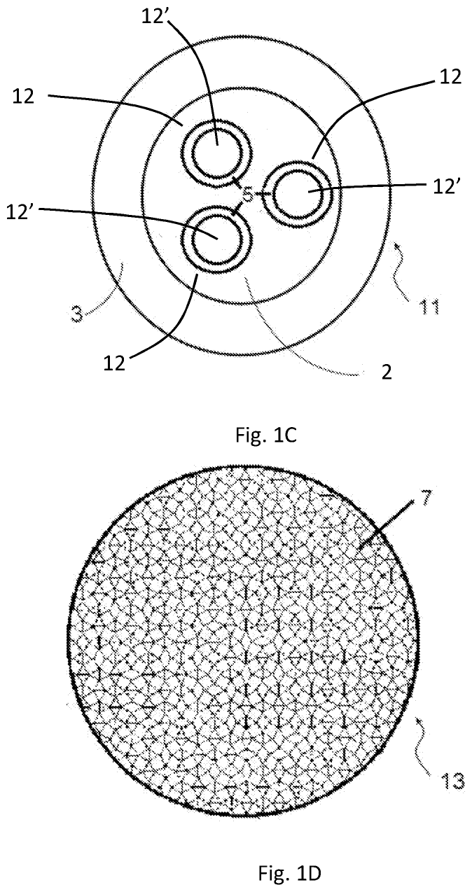

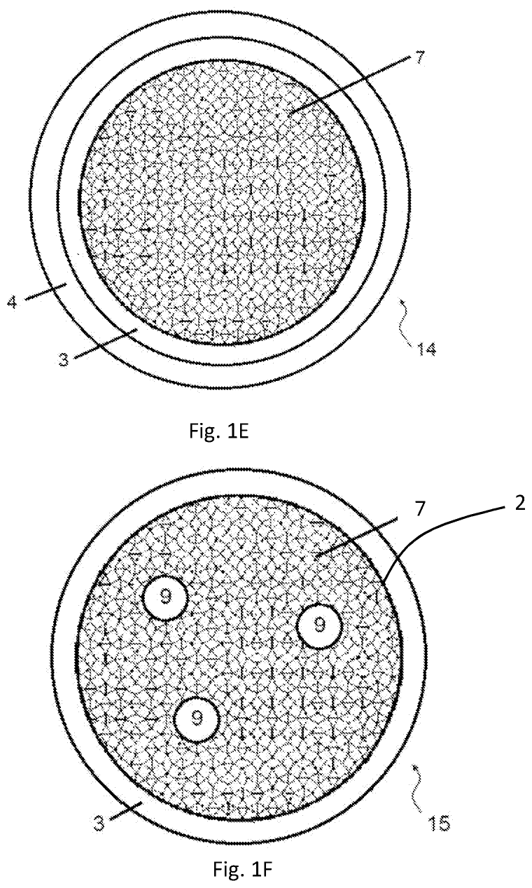

FIG. 1A depicts a core shell structure (1) comprising (i) a core (2) comprising at least one tracer and (ii) a shell (3) comprising a polymeric microencapsulant.

FIG. 1B depicts a core multi shell structure (10) comprising (i) a core (2) comprising at least one tracer, (ii) a first shell (3) comprising a polymeric microencapsulant; and (iii) one or more additional shells (4) that at least partially cover the first shell.

FIG. 1C depicts a multi core shell structure (11) comprising (i) a core (2) comprising a plurality of sub cores (12) each comprising at least one tracer (12′) within the sub core (12) and optionally having a shell (5) at least partially covering the sub cores (12), and (ii) a shell (3) comprising a polymeric microencapsulant around the core (2). The multi core shell structure (11) can also contain one or more additional shells that at least partially cover the first shell as shown in FIG. 1B as item (4).

FIG. 1D depicts a micro matrix (13) comprising at least one tracer entrapped within a three dimensional polymeric microencapsulant micro matrix (7).

FIG. 1E depicts a micro matrix with a shell structure (14) comprising (i) a micro matrix (7) comprising at least one tracer entrapped within the micro matrix (7), (ii) a first shell (3) comprising a polymeric microencapsulant, where the first shell at least partially covers the micro matrix (7); and (iii) one or more additional shells (4) that at least partially cover the first shell (3). The structure can have only a first shell (3) and not have one or more additional shells (4).

FIG. 1F depicts a multi core micro matrix with a shell structure (15) comprising (i) a core (2) comprising a micro matrix (7) comprising a three dimensional polymeric microencapsulant and a plurality of sub-cores (9) within the micro matrix (7), (ii) a first shell (3) comprising a different polymeric microencapsulant. The structure can also contain one or more additional shells (not shown) that at least partially cover the first shell (3), as shown as item 4 in FIG. 1E.

The microcapsules, cores and shells are shown graphically in FIGS. 1A-1F as circles for ease of illustration. The microcapsules can have any shape, including, but not limited to a sphere, a rod, an ovoid, a pseudo cuboid, a ring, etc.

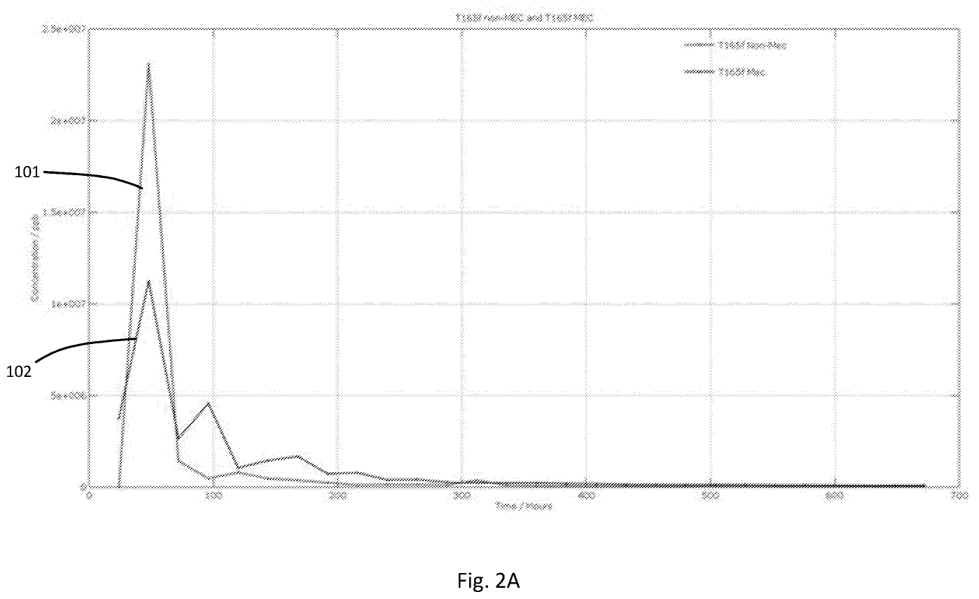

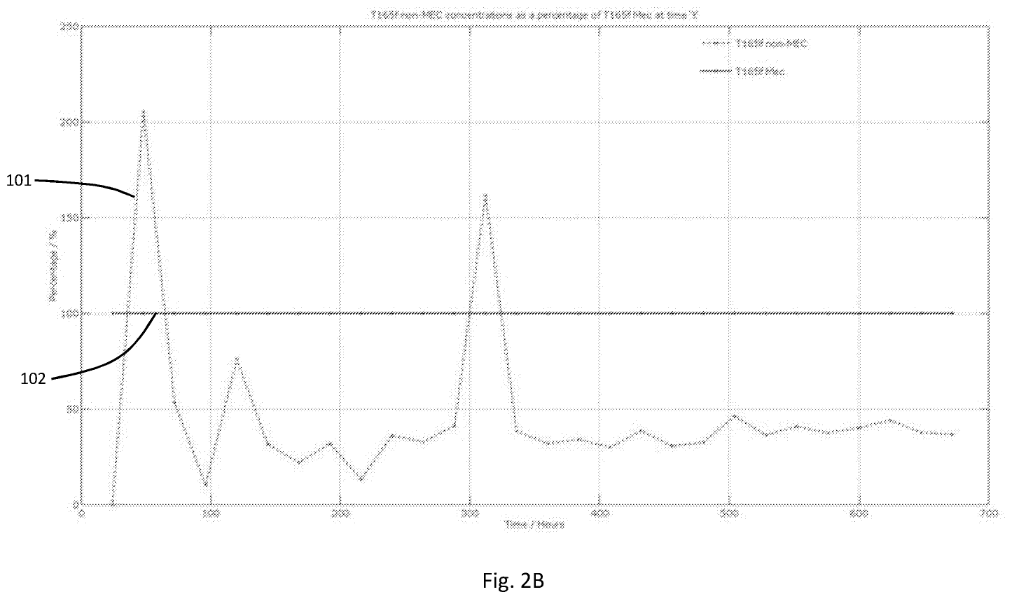

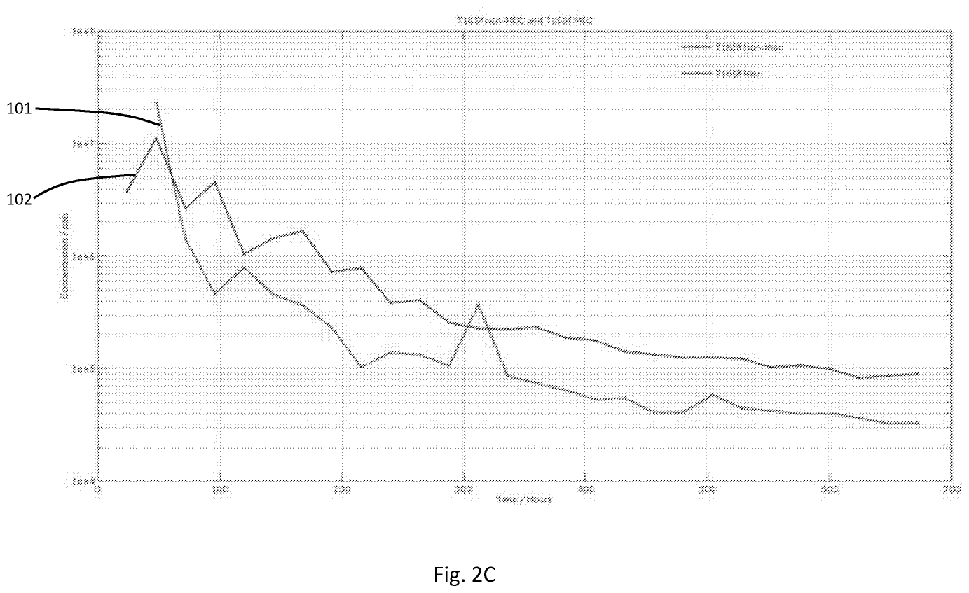

In FIGS. 2A to 2C the concentration of a tracer (Tracerco, T165f) in an eluent is plotted against time. The plots are obtained by placing a tracer-carrying material into the eluent with stirring, taking samples of the eluent at various times and determining the amount of the compound of interest that is present in the eluent over time. The testing is carried out at elevated temperatures representing those found in a hydrocarbon reservoir using an eluent representative of oil. Data is plotted for a tracer-carrying material according to the invention (102-“T165f MEC”), in which the tracer is microencapsulated and integrally incorporated into granulated particles and another tracer-carrying material (101-“T165f non-MEC”) in which the tracer is not microencapsulated. FIG. 2A is a plot of the tracer concentrations in the eluent over time. FIG. 2B is a plot in which the tracer concentrations are plotted as a percentage of the tracer concentration of the tracer from the tracer-carrying material in which the tracer is microencapsulated (102). FIG. 2B is useful for comparing the relative concentrations of the tracers over time and it can be seen that the tracer from the T165f non-MEC material (101) shows a higher concentration initially, but that the T165f MEC (102) shows an improved sustained release over time. FIG. 2C is plotted on a logarithmic scale, and it can again be seen that the T165f non-MEC material (101) releases rapidly initially but then falls away, while the T165f MEC material (102) shows a more even, sustained release. The ability to alter the microencapsulation parameters also means that the release profile of the tracer-carrying material in which the tracer is microencapsulated can be tuned, while the release profile from the non-microencapsulated material cannot be adjusted so easily.

### EXAMPLES

Aspects of the invention will be illustrated in the following examples.

### Example 1-Preparation of Microcapsules Containing a Tracer

A tracer (Tracer A: a solid haloaromatic compound, density 2.3 g/cm3 at 25° C. and 1 atm) was ground and filtered through a 100 μm sieve. 1.2 g carboxylmethylcellulose sodium salt (Sigma) was dissolved in 78.3 g water and then mixed with 15.9 g Beetle resin (BIP) and 0.35 g formic acid (96%, Sigma) to form an aqueous mixture. The aqueous mixture was stirred at 25° C. for 1 hour. 60 g of the sieved tracer and the aqueous mixture were then homogenised together for 5 minutes using a Silverson L4R laboratory homogeniser. During the homogenisation process, 300 g water was added to dilute the mixture. The homogenised mixture was stirred at 25° C. for 2 hours and then at 65° C. for 2 more hours. The resultant dispersion was filtered, dried in air for 3 days and then dried in a vacuum oven at 50° C. for 8 hours. The dried powder product containing the encapsulated tracer was filtered through a 425 μm sieve. Total tracer content in the final powder product was 84%. The powders were dispersed in deionised water and tested using a Malvern Mastersizer 2000 under 85% ultrasonication for particle size. The measured volume weighted mean particle size was 23 μm.

### Example 2-Preparation of Microcapsules Containing a Second Oil Tracer

A second tracer (Solid tracer B: a haloaromatic compound, density 1.2 g/cm3 at 25° C. and 1 atm) was sieved through a 100 μm sieve. 7.7 g carboxylmethylcellulose sodium salt (Sigma) was dissolved in 900 g water and then mixed with 101.8 g Beetle resin (BIP) and 2.24 g formic acid (96%, Sigma) to form an aqueous mixture. The aqueous mixture was stirred at 25° C. for 1 hour.

640 g of the sieved tracer and the aqueous mixture were then homogenised together for 15 minutes using a Silverson L4R laboratory homogeniser. During the homogenisation, 300 g water was added to dilute the mixture. The homogenised mixture was stirred at 25° C. for 2 hours and then at 65° C. for 2 more hours. The resultant dispersion was filtered, dried in the air for 3 days and then dried in a vacuum oven at 50° C. for 8 hours. The dried powder product was filtered through a 425 μm sieve. Total tracer content in the final powder product was 85%.

### Example 3-Microencapsulation of Third Oil Tracer

A third tracer (Tracer C: a solid halogenated benzene tracer, density 3.0 g/cm3 at 25° C. and 1 atm) was ground and sieved through a 100 μm sieve. 640 g of the sieved tracer was microencapsulated following the procedure outlined in Example 2. The powders were dispersed in deionised water and tested using a Malvern Mastersizer 2000 under 85% ultrasonication for particle size. The measured volume weighted mean particle size was 10.5 μm. The total tracer content in the final powder product was 88%.

### Example 4-Microencapsulation of a Liquid Tracer

An oil tracer (Tracer D: A liquid benzene tracer substituted with mixed halogens, density 2.0 g/cm3 at 25° C. and 1 atm) was encapsulated as described below. 1.52 g carboxylmethylcellulose sodium salt (Sigma) was dissolved in 81.8 g water and then mixed with 18.63 g Beetle resin (BIP) and 0.36 g formic acid (96%, Sigma) to form an aqueous mixture. The aqueous mixture was stirred at 25° C. for 1 hour. 0.57 g Narad Solvent Red 175 dye was dissolved in 60 g of the liquid tracer. The liquid tracer/dye mixture and the aqueous mixture were then homogenised together for 5 minutes using a Silverson L4R laboratory homogeniser. During the homogenisation process, 120 g water was added to dilute the mixture. The homogenised mixture was stirred at 25° C. for 2 hours and then at 65° C. for 2 more hours. The resultant dispersion was filtered, dried in the air for 3 days and then dried in a vacuum oven at 40° C. for 10 hours. The dried powder product containing the encapsulated tracer was filtered through a 425 μm sieve.

### Example 5-Microencapsulation of a Biocide

A biocide (Biocide A: an anthraquinone compound, density ˜1.3 g/cm3 at 25° C. and 1 atm) was encapsulated as described below. 1.2 g carboxylmethylcellulose sodium salt (Sigma) was dissolved in 78.3 g water and then mixed with 15.9 g Beetle resin (BIP) and 0.35 g formic acid (96%, Sigma) to form an aqueous mixture. The aqueous mixture was stirred at 25° C. for 1 hour. 60 g of the biocide and the aqueous mixture were then homogenised together for 5 minutes using a Silverson L4R laboratory homogeniser. During the homogenisation process, 300 g water was added to dilute the mixture. The homogenised mixture was stirred at 25° C. for 2 hours and then at 65° C. for 2 more hours. The resultant dispersion was filtered, dried in the air for 3 days and then dried in a vacuum oven at 50° C. for 8 hours. Total biocide content in the final powder product was 85%. The dried powder product containing the encapsulated biocide was filtered through a 425 μm sieve.

### Example 6-Granulation

Using an Eirich EL1 granulator, solid substrate, and water, a material was granulated to particles 0.1-3 mm in size. The material was sieved after manufacture and some particles were tested for moisture content using a Mettler Toledo infrared moisture balance to determine loss on drying (LOD). The preferred general method involved charging around 400 g of substrate to the EL1 and closing the lid. The EL1 was set to the granulation angle. The EL1 was then run at 4 m/s for 30 s. Around 190 ml of water was then added over 60 s with the EL1 running at 4 m/s. The EL1 was then sped up to 20 m/s for 30-60 s until seeds were seen. The speed was then reduced to 6 m/s until granules were seen. 40 g of substrate was added to dry the surface of the particles, which were then discharged and sieved. All samples were aged at 45° C. for 24 hours in a sealed bag. Preferably the bag is about 80% full by volume. The presence of moisture within the bag may be indicative of sufficient humidity during the aging process.

The following specific tests were carried out:

Test 1

400.1 g ρ-alumina was placed in the EL1 and mixed at 4 m/s with the mixer set to the granulation angle. 205.0 g water was added over 40 s with the EL1 running at 4 m/s. The EL1 was increased to 20 m/s for 30 s, at which point seeds were seen. The EL1 speed was reduced to 6 m/s for 45 s, at which point granules were seen. 40 g of ρ-alumina was added to dry the surface of the particles and mixed for 30 s with the EL1 running at 4 m/s. The granules were discharged and sieved between 850 μm and 2800 μm. 61.53 g of granules were between 850 μm and 2800 μm, 376.6 g were smaller than 850 μm and 8.185 g were larger than 2800 μm.

Test 2a

395 g ρ-alumina and 5.09 g Attagel® were hand mixed and then machine mixed in the EL1 for 30 s with the EL1 running at 4 m/s. 200 g water was added over 90 s with the EL1 running at 4 m/s. The EL1 was increased to 20 m/s for 20 s, at which point seeds were seen. The EL1 speed was reduced to 6 m/s for 10 s, at which point granules were seen. The LOD was 30%.

Test 2b

395.4 g ρ-alumina and 4.9 g Attagel® were hand mixed and then machine mixed in the EL1 for 30 s with the EL1 running at 4 m/s. 194.9 g water was added over 60 s with the EL1 running at 4 m/s. The EL1 was increased to 20 m/s for 30 s, at which point seeds were seen. The EL1 speed was reduced to 6 m/s for 30 s, at which point granules were seen. The EL1 was allowed to continue running, which resulted in larger granules. Those were broken down by increasing the speed to 20 m/s, then adding 10 ml of water with the El1 at 6 m/s, then increasing the speed to 20 m/s for 15 s, then running at 6 m/s for 30 s until particles were seen. 40 g of ρ-alumina was added to dry the surface of the particles. The LOD was 26.28%. The main fractions in the sieving were <425 μm and 425-1000 μm.

Test 3

400 g ρ-alumina was placed in the EL1 and 210 g water was added over 60 s with the EL1 running at 4 m/s. The EL1 was increased to 20 m/s for 20 s, at which point seeds were seen. The EL1 speed was reduced to 6 m/s for 30-40 s, at which point granules were seen. 40 g of ρ-alumina was added to dry the surface of the particles and mixed for 30 s with the EL1 running at 4 m/s. The granules were discharged and sieved. The LOD was 29.46%.

Test 4

395.0 g boehmite and 5 g Attagel® were hand mixed and then machine mixed in the EL1 for 30 s with the EL1 running at 4 m/s. 195 g water was initially added, before further additions of 20 g, 26.2 g, 145.8 g, and 53.0 g of water. Further additions of 40 g and then 20 g of boehmite were then made. The particles were larger, with >70% being larger than 2 mm. The LOD was 51.4%.

Test 5

395.0 g gibbsite and 5 g Attagel® were hand mixed and then machine mixed in the EL1 for 30 s with the EL1 running at 4 m/s. 195 g water was added, which produced a wet agglomerate. A further 250 g of gibbsite was added and the EL1 speed increased to 20 m/s, which resulted in granules. 40 g of gibbsite was added to dry the granules, which were discharged and sieved.

Crush testing was carried out on a ½ tonne testing machine. In each test a single granule was placed on the crush plate, the guard was closed, and the test button pressed. The piston was depressed until a breaking force was detected. If the particle was soft and crushed gradually rather than breaking, then the test read maximum (50 kg) and was recorded as a failure. The material from test 1 was dried in an oven at 60° C. for 24 hours. The material from tests 2b, 4a and 5 were dried in a Sherwood Tornado 501 fluid bed drier with the following settings: 60° C. air temp; 40 air speed; 5 minutes.

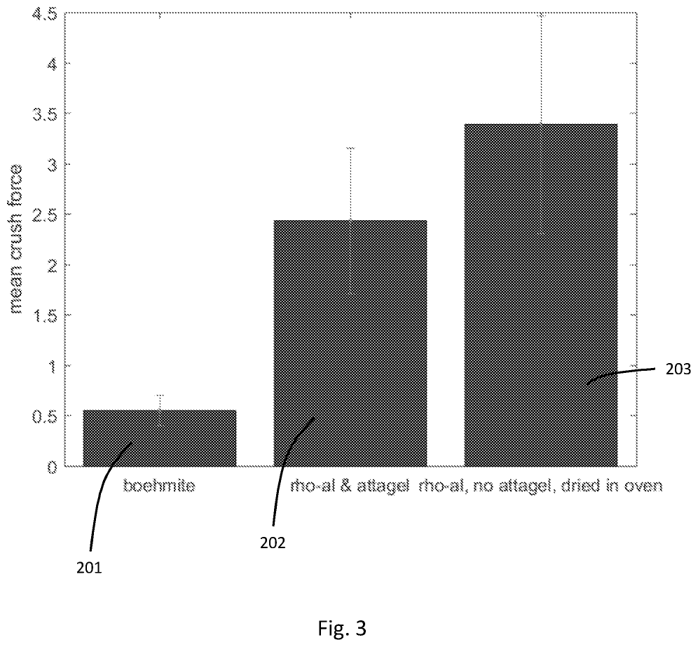

FIG. 3 compares the crush strength of the materials from test 4 (201), test 2b (202) and test 1 (203). Material from test 5 failed the test. The materials made from ρ-alumina show a significant improvement in crush strength.

1. An oil field chemical-carrying material comprising granulated particles comprising alumina and having been aged by heating the particles in a sealed or humid environment, wherein an oil field chemical is integrally incorporated into the granulated particles.

2. The oil field chemical-carrying material according to claim 1, wherein the oil field chemical is microencapsulated.

3. The oil field chemical-carrying material according to claim 1, wherein the particles are from 0.1 to 2 mm in size.

4. The oil field chemical-carrying material according to claim 1, wherein the particles are granulated using water as a binder.

5. The oil field chemical-carrying material according to claim 1, wherein the granulated particles do not comprise any polymeric binder.

6. The oil field chemical-carrying material according to claim 1, wherein the microencapsulation controls the rate of release of the tracer from the tracer-carrying material.

7. The oil field chemical-carrying material according to claim 1, wherein the granulated particles are proppant particles.

8. The oil field chemical-carrying material according to claim 1, wherein the granulated particles are uncoated.

9. The oil field chemical-carrying material according to claim 1, wherein the granulated particles are coated.

10. The oil field chemical-carrying material according to claim 1, wherein the oil field chemical is tracer.

11. A process for producing an oil field chemical-carrying material, the process comprising: mixing alumina with a microencapsulated oil field chemical to produce a mixture, granulating the mixture using water as a binder to form granulated particles, and aging the granulated particles by heating them in a sealed or humid environment.

12. The process according to claim 11, comprising drying the aged granulated particles.

13. The process according to claim 11, wherein the alumina is ρ-alumina.

14. The process according to claim 11, wherein the heating is carried out at a constant temperature for a period of at least 4 hours.

15. The process according to claim 14, wherein the heating is carried out for a period of 4 to 48 hours.

16. The process according to claim 11, wherein the heating is carried out at a temperature of 30 to 90° C., more preferably 45 to 70° C.

17. The process according to claim 11, wherein the heating is carried out in a sealed environment created by placing the granulated particles in a container, for example a bag, and sealing the container prior to the heating.

18. The process according to claim 11, wherein the material is dried at a temperature of 40 to 80° C., more preferably 50 to 70° C.

19. The process according to claim 11 wherein the process comprises adding a rheology modifier to the mixture.

20. The process according to claim 11, wherein the oil-field carrying chemical is a tracer.

21. An oil field chemical-carrying material produced by the process of claim 11.

22. A method of delivering an oil field chemical, the method comprising injecting into a well penetrating a hydrocarbon reservoir a fluid containing an oil field chemical-carrying material comprising granulated particles wherein a microencapsulated oil field chemical is integrally incorporated into the granulated particles.

23. The method according to claim 22, wherein the oil field chemical-carrying material is an oil field chemical-carrying material according to any of claim 1 to 10 or 21.

24. The method according to claim 22, wherein the oil field chemical-carrying material comprises granulated particles in which two or more different microencapsulated oil field chemicals are integrally incorporated.

25. The method according to claim 24, wherein the microcapsule of a first microencapsulated oil field chemical provides a release at a first rate for the first microencapsulated oil field chemical, and the microcapsule of a second microencapsulated oil field chemical provides for release at a different, more rapid, rate for the second microencapsulated oil field chemical.

26. A method of monitoring a subterranean formation, the method comprising injecting, as part of a hydraulic fracturing operation, a fluid containing granulated particles comprising alumina wherein a microencapsulated tracer is integrally incorporated into the granulated particles, and detecting the tracer in fluids produced from the formation.

27. The method according to claim 26, wherein the tracer passes through the microencapsulation and is released from the particle over a period of time.

28. A method of tracing a flow of fluid from a hydrocarbon reservoir comprising the steps of placing within a well penetrating said reservoir a tracer-carrying material according to claim 10, thereafter collecting a sample of fluid flowing from the well, and analysing said sample to determine the presence or absence of the tracer.

29. A method of hydraulic fracturing a subterranean formation, the method comprising injecting into the subterranean formation a fluid containing an oil field chemical-carrying material according to claim 1.
